(19) United States
(12) Patent Application Publication
(10) Pub. No.: US 2023/0307677 A1
(43) Pub. Date: Sep. 28, 2023

(54) ELECTRODE STRUCTURES FOR MEMBRANE ELECTRODE ASSEMBLIES OPERATING GREATER THAN 8OºC

(71) Applicant: Advent Technologies Holdings, Inc., Boston, MA (US)

(72) Inventors: Ryan Pavlicek, Roslindale, MA (US); Cynthia Lemay Olson, Chelmsford, MA (US); Amariah Condon, Boston, MA (US); George Paloumbis, Patras (GR); Emory Sayre De Castro, Nahant, MA (US)

(21) Appl. No.: 17/704,987

(22) Filed: Mar. 25, 2022

(51) Int. Cl. H01M 8/1004

(52) U.S. Cl. CPC H01M 8/1004

(57) ABSTRACT

Aspects of the invention provide novel electrodes to be employed with membranes that can operate in fuel cell mode between at least 80- and 240-degrees C. The electrodes comprise a carbon-based substrate, e.g., of woven cloth or paper, a hydrophobic binder-containing microporous layer, e.g., polytetrafluoroethylene (PTFE), and a catalyst layer comprising electrocatalysts and binders demonstrating ionic conductivity over a range of dry and wet operating conditions. According to some aspects of the invention, at least one layer of the microporous layer or catalyst layer has defined pore structure and particle size distribution.

### DESCRIPTION OF THE RELATED ART

The present invention relates to electrodes and membrane electrode assemblies. The invention has application, for example, in high-temperature proton exchange membrane fuel cells (HT-PEMFCs).

Karl V. Kordesch is often credited with inventing the modern gas diffusion electrode, as disclosed in U.S. Pat. No. 3,477,877. However, that was designed specifically for highly alkaline solutions used for the hydrogen oxidation reaction (HOR) and oxygen reduction reaction (ORR). Eventually, these electrodes were incorporated into MEAs for fuel cell operation, with the invention of Chemours' Nafion® and other perfluorosulfonic acid (PFSA) membrane materials. Following the development of such membranes, fuel cells often operated using catalyst-coated membranes (CCMs), as disclosed in U.S. Pat. No. 5,211,984, through which a catalyst layer is coated not onto a carbon substrate, but onto an inert carrier, and then the layer is decaled onto the membrane itself. A separate carbon substrate and microporous layer is then applied to each side of the CCM to complete the required pore structure. Perhaps the greatest development towards modern MEAs was through the development of roll-to-roll coating processes, whereby the gas diffusion electrodes are produced in large rolls, then cut into sheet form before being laminated to membranes. This process is outlined in U.S. Pat. No. 6,103,077.

In traditional HT-PEMFCs, a membrane is either imbibed with or polymerized in the presence of variations of phosphoric acid. This creates a network of hydrogen-bonded acid. During membrane electrode assembly (MEA) preparation, acid migrates from the membrane to the electrodes, allowing for a proper three-phase interface of acid, catalyst, and fuel. Prominent examples of such membrane technology include polybenzimidazole (PBI) or Advent Technologies' aromatic polyether membrane (TPS®). Significant limitations in operation of these systems are resultant of this weak bonding interaction. Operation at below 100° C. is not possible as the water generated at the cathode can dilute and remove the acid. Similarly, requiring a cell temperature over 100° C. also increases system start-up time. Additionally, it is not possible to operate with highly humidified feed gasses due to acid removal from the same mechanism as described with water production. These limitations are not present in low-temperature proton exchange membrane fuel cell (LT-PEMFC) systems, as the polymer electrolyte membrane does not contain free acid, but is an inherently proton-conductive polymer material of the perfluorosulfonic acid (PFSA) class of materials, such as Chemours' Nafion®, and the catalytic layer also includes ionomers similar to PFSAs.

A new paradigm for HT-PEMFCs is called ion-pair technology, and this approach varies significantly from the present technology in that the acid is ionically bound to quaternary ammonium groups within the polymer. Therefore, the amount of acid required to create a proton-conductive system is far less due to being more tightly bound. Additionally, ion-pair systems can be operated under much wider conditions than traditional HT-PEMFCs, including operation at below 100° C., which facilitates a reduced start-up time, as well as operation under a wider range of humidification. Performance of ion-pair systems have shown to be on par with state-of-the-art LT-PEMFC systems. In essence, ion-pair technology can match the performance of LT-PEMFC (while surpassing existing HT-PEMFC) and can be operated under much wider conditions, making them suitable to environments and conditions seen across the planet. It can achieve these performances without sacrificing any of the benefits that traditional HT-PEMFC systems have over LT-PEMFC systems, including greater tolerance of reformate contaminants including CO, CO₂, and sulfides, and better heat management.

While ion-pair membrane technology has been slowly developed and has evolved over the last 10 years, no development has been done on the required gas diffusion electrodes (GDEs) to meet such targets, and electrodes designed for MEAs based on PBI or TPS® utilized loosely bound phosphoric acid, unlike that in ion pair assemblies.

An object of the invention is to provide improved electrodes for use fuel cells and, more particularly, by way of example for use in proton exchange membrane fuel cells, and still more particularly, by way of further example, for use in high-temperature proton exchange membrane fuel cells.

A further object of the invention is to provide improved electrodes for ion-pair membrane electrode assemblies, e.g., with long lifetimes and operational over a wide range of temperatures, humidities and/or other operating conditions.

### SUMMARY OF THE INVENTION

The foregoing objects are among those achieved by the invention, aspects of which provide novel electrodes for use with membranes that can operate in fuel cell mode between at least 80 and 240 degrees C. and between 0 and 100% relative humidity. The electrodes comprise a carbon-based substrate, e.g., of woven cloth or paper, a hydrophobic binder-containing microporous layer, e.g., of polytetrafluoroethylene (PTFE), and a catalyst layer comprising electrocatalysts and binders demonstrating ionic conductivity over a range of dry and wet operating conditions. According to some aspects of the invention, at least one layer of the microporous layer or catalyst layer has a defined pore structure and particle size distribution.

Further aspects of the invention provide membrane electrode assemblies, e.g., with electrodes of the type described above.

Still further aspects of the invention provide fuel cells, e.g., with membrane electrode assemblies and electrodes of the type described above.

### BRIEF DESCRIPTION OF THE DRAWINGS

A more complete understanding of the invention may be attained by reference to the drawings, in which:

FIG. 1a depicts a fuel cell containing membrane electrode assemblies of the type including an electrode according to one practice of the invention;

FIG. 1b depicts specifically a membrane electrode assembly of the type including an electrode according to one practice of the invention;

FIG. 2 depicts performance of an ion-pair MEA that includes an electrode according to the invention as compared to traditional PBI-based MEA;

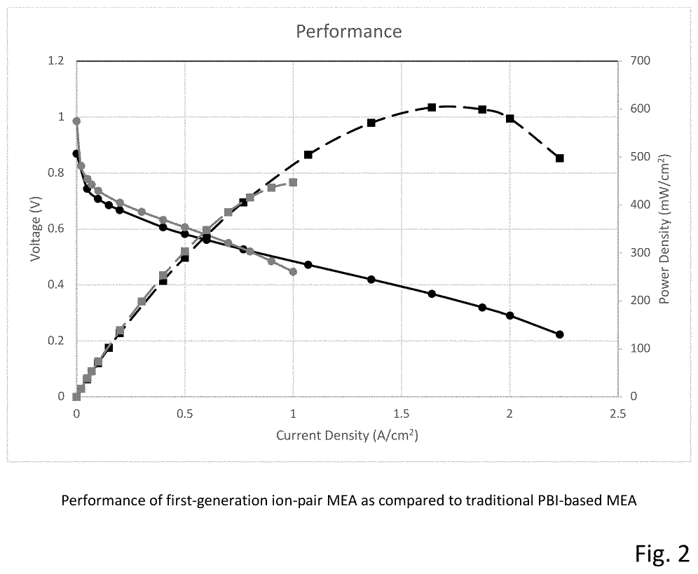

FIG. 3 depicts performance of an ion-pair MEA that includes an electrode according to the invention as a function of anode and cathode bubble point as determined by CFP; and

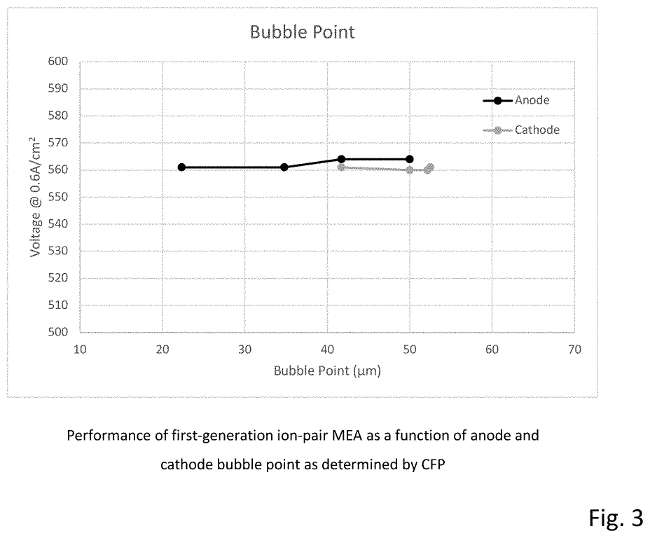

FIG. 4 depicts performance of an ion-pair MEA that includes an electrode according to the invention as a function of anode and cathode mean pore size as determined by CFP.

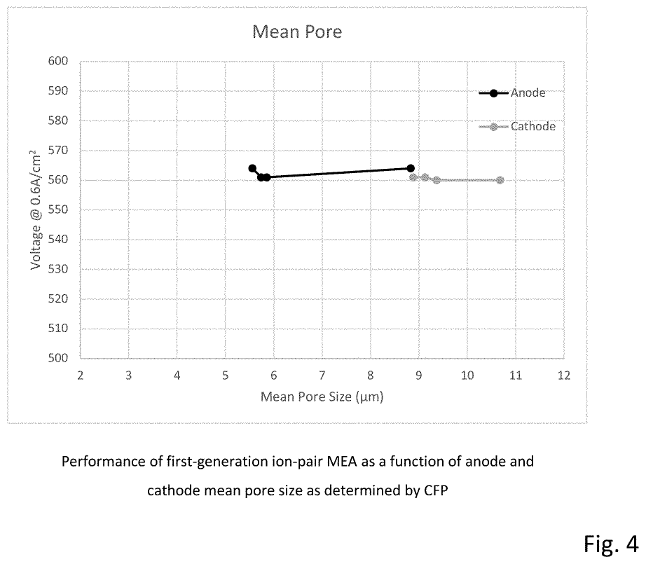

### DETAILED DESCRIPTION OF THE ILLUSTRATED EMBODIMENT

Described below are novel electrodes designed for use in partnership with ion-pair-based membranes in membrane electrode assemblies, as well as the fuel cells that incorporate them. With respect to the electrodes, we have found a novel combination of porosity for the microporous layer with catalyst layer that have well-defined porosity profiles, as well as solvent mixes to facilitate porosity. An additional benefit to the electrodes described within this application as compared to current HT-PEMFC electrodes stems from the removal of the previous requirement that the electrodes be oven processed at a temperature usually greater than 300° C. to activate the hydrophobic binders.

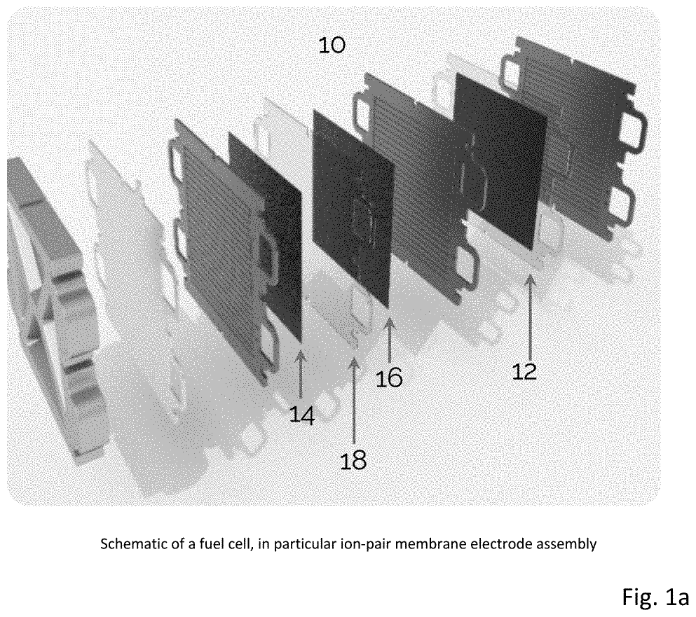

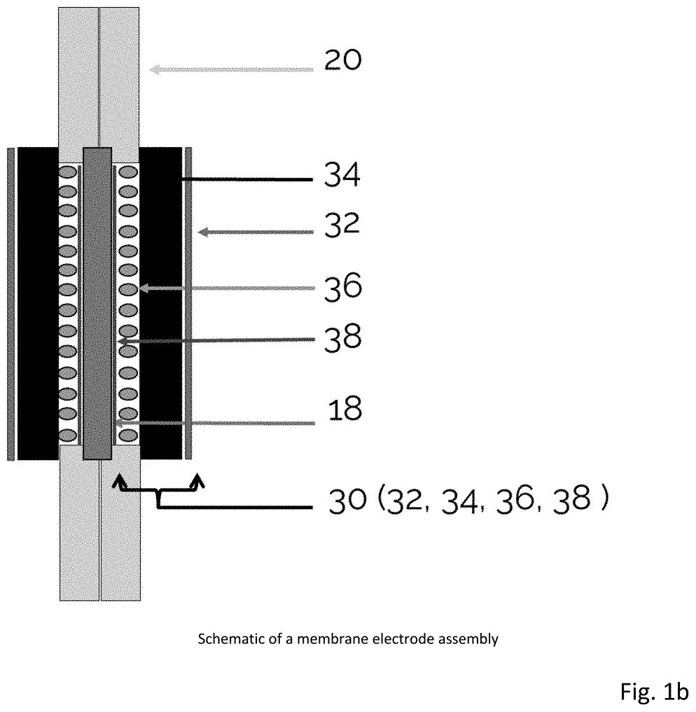

Referring to FIG. 1a, there is shown a fuel cell 10 having an ion-pair membrane electrode assembly (MEA) 12 of the type with which the invention is practiced. The fuel cell is of the conventional type known in the art as adapted in accord with the teachings hereof. The MEA 12 includes an anode gas diffusion electrode 14, a cathode gas diffusion electrode 16, a proton-conductive ion-pair membrane 18, and interior gaskets 20.

With further reference to FIG. 1a, depicted in FIG. 1b, a gas diffusion electrode 30 according to the invention can include a carbon substrate or support layer 32, a carbon & hydrophobic binder-containing microporous layer 34 such as PTFE, and a catalyst layer 36 that additionally contains ionomeric binders such as a phosphonated polymer. In addition, the catalyst layer of the electrodes may also contain a sulfonic acid polyelectrolyte such as perfluorosulfonic acid (PFSA) to create tighter interactions with the phosphonated polymer. A thin topcoat 38 of ionomer & phosphoric acid may also be introduced to improve interfacial characteristics with the ion-pair membrane.

The role of the carbon support layer 32 is to provide an ion-permeable substrate upon which the other, active layers of the electrode are deposited. Carbon support materials for the carbon support layer 32 are chosen based on numerous parameters, including thicknesses less than 400 μm, high inherent hydrophobicity, high conductivity, high acid-resistance, and a well-defined pore distribution. Materials with a preferred combinations of those parameters are characterized by methods including but not limited to Scanning Electron Microscopy, Cobb titrations and contact angle measurements, electrical conductivity tests, acid-resistance studies, and Capillary Flow Porometry, though it will be appreciated that the invention can be practiced with materials having other combinations of these and other parameters. Suitable such substrates 32 can include carbon or graphite-based woven clothes or papers. Such as those provided by AvCarb (Homepage—AvCarb, Lowell, MA); SGL Carbon (Germany, under Sigracet Fuel Cell Components); or Freudenberg (Germany, https://fuelcellcomponents.freudenberg-pm.com/).

The role of a microporous layer 34 is to provide an optimized pore structure to facilitate both gas transport to the catalytic active sites as well as water (both provided and generated) away from the active sites, which can otherwise inhibit mass transport within the fuel cell. Microporous layer 34 comprises a carbon and hydrophobic binder. In the illustrated embodiment, that layer is fabricated using formulations of the type known in the art for use with gas diffusion layers (GDLs) based on carbon black and a hydrophobic agent such as PTFE; see, for example, X. L. Wang et al Micro-porous layer with composite carbon black for PEM fuel cells Electrochimica Acta 51 (2006) 4909-4915.

In the illustrated embodiment, the microporous layer is fabricated by applying a slurry made from such an aforesaid formulation to the carbon substrate 32 in a process that can either be a single coat or multi-coat, with the microporous layer being dried after each coat. Microporous layer 34 of other embodiments may comprise other formulations, whether based on carbon and a hydrophobic binder or otherwise. Examples include carbon blacks from Cabot Carbon (e.g. Vulcan XC72), acetylene blacks, or modified carbon blacks from Pajarito Powder LLC, New Mexico In some embodiments, oven activation of the microporous layer 34 is done following completed deposition of the MPL 34.

The role of the catalyst layer 36 is to enable chemical reactions that, on the anode side, free-up protons, e.g., from hydrogen molecules, and, on the cathode side, facilitate combination of those protons and oxygen to form water. In the illustrated embodiment, the layer 36 is fabricated from mixed aqueous/organic catalyst inks that are generated using a carbon-supported catalyst, which can be metallic or non-metal containing, phosphonated polymer ionomer, and optionally a sulfonic acid binder. The base solvent is a combination of, but not necessarily solely comprising, water, 1-propanol, 2-propanol, NMP, DMAC, DMSO, DMF, and cyclopentanone. Mixing is done through a combination of high-shear and non-shear mixing to achieve desired particle size distribution. To form the layer 36, the catalyst inks are applied to the previously applied microporous layer 34 in a process that can either be a single coat or multi-coat, with the catalyst layer being dried after each coat. Catalyst layer 36 of other embodiments may comprise other formulations, such as, for example, metallic catalyst that are un-supported (lacking carbon support), catalysts on non-carbon-based support materials, such as metallic supports or oxide materials such as Silicon Dioxide.

In some embodiments, electrodes according to the present invention can be processed with a sintering step above 300° C., e.g., of the type known in the art for use in fabrication of HT-PEMFC electrodes, though this is not a requirement of the invention.

In electrodes according to the illustrated embodiment, particle size distributions of the materials in both the microporous layers 34 and in the catalyst layers 36 are preferably less than 0.2 μm, as determined via ink studies and/or electro-acoustic particle size analysis, while porosity of both the substrate 32 with microporous layer 34 as well as the complete electrode 36, as determined, e.g., via capillary flow porometry, is preferably between 20 μm and 70 μm. Moreover, packing of the catalyst layer 36 onto the microporous layer 34 is preferably achieved by a combination of controlling the hydrophobicity of the MPL as well as the solvent mix in the catalyst ink . . . to limit catalyst falling into the pores of the microporous layer, therefore reducing electrode activity through inaccessible active sites. Confirmation is acquired through Scanning Electron Microscopic analysis of the interface of the catalyst layer and microporous layer.

Further characteristics and parameters of preferred electrodes according to the invention are set forth below. Achieving such characteristics and parameters is within the ken of those skilled in the art in view of the teachings hereof:
Operation from 80° C. to 240° C., including long lifetime across that entire range, as determined by fuel cell performance & durability studies
Operation under a wide range of humidity from 0-100% relative humidity (RH)
Electrodes show improved performance over traditional HT-PEM electrodes when used with ion-pair technology membranes
The anode catalyst layer having an optimized pore structure for operation between 80° C. and 240° C.
The cathode catalyst layer having an optimized pore structure for operation between 80° C. and 240° C.
The anode microporous layer having an optimized pore structure that is optimized for performance between 80° C. and 240° C. in the presence of hydrogen or reformate gas mixes containing but limited to CO, CO₂, sulfides and water vapor
The cathode microporous layer having an optimized pore structure that is optimized for performance between 80° C. and 240° C. in the presence of air or oxygen containing water vapor.
   More specifically regarding the microporous layer 34:
The microporous layer having bubble points determined by Capillary Flow Porometry (CFP) of less than 20 μm when a carbon or graphite paper is used, and less than 50 μm when a carbon or graphite weave is used.
Mean pore sizes be less than 3 um when a carbon or graphite paper is used, and less than 10 um when a carbon or graphite weave is used, as determined by Capillary Flow Porometry (CFP).
The microporous layer 34 thicknesses between 200 μm and 500 μm following any drying and sintering steps, including the thickness of the base substrate, as determined by Scanning Electron Microscopy (SEM).
   More specifically for anodes:
Catalyst loading of between 0.05 mg/cm² and 0.7 mg/cm² (total loading or PGM loading based on catalysts), as determined by X-Ray Fluorescence (XRF)
The catalyst layer having bubble points determined by Capillary Flow Porometry (CFP) of less than 20 μm when a carbon or graphite paper is used, and less than 70 μm when a carbon or graphite weave is used.
Catalyst by weight in the range of 20%-90%, and more particularly 70%-90% in the dried catalyst layer, with all binders in the range of 10%-30%
Catalyst layer thickness of between 10 μm and 50 μm, as determined by Scanning Electron Microscopy (SEM)
   More specifically for cathodes:
Catalyst loading of between 0.05 mg/cm² and 1.0 mg/cm² (total loading or PGM loading based on catalysts), as determined by X-Ray Fluorescence (XRF)
The catalyst layer having bubble points determined by Capillary Flow Porometry less than 30 μm when a carbon or graphite paper is used, and less than 70 μm when a carbon or graphite weave is used.
Mean pore sizes should be less than 20 μm for both carbon and graphite papers and weaves.
Catalyst by weight in the range of 20%-90%, and more particularly 70%-90% in the dried catalyst layer, with all binders in the range of 10%-30%
Catalyst layer thickness of between 10 μm and 60 μm, as determined by Scanning Electron Microscopy (SEM)

A more complete understanding of practice of the invention may be attained through study of the examples below.

### Examples

Example 1—Microporous Layer: A woven or paper cloth or graphite material is chosen for coating. The microporous layer ink is prepared by mixing the desired carbon, for example Soltex Acetylene Black or Vulcan XC-72, with water and other surfactants. A series of inks with high-shear mixing between 15 and 90 minutes are prepared. A fluorinated hydrocarbon, for example PTFE, is added and the mixture is mixed on a non-shear mixer for 30 to 60 minutes. Other additives such as thickeners may be used to improve ability to coat. The mixture is applied to the chosen web, with the web being air-dried in between each coat, until the desired loading is achieved (3 to 50 g/m²). Following completion of coating, the material is heat-treated to 340° C. for between 15 and 30 minutes. This completes the gas diffusion layer (GDL), or microporous layer (MPL)

Example 2—Anode: An already-prepared MPL is used as a substrate. Catalyst inks are prepared using an aqueous/organic mixture, for example water and 1-propoanol. This mixture contains solvent, catalyst, for example a Platinum-alloy supported on XC-72 or KB-300, phosphonated polymer, and potentially sulfonic acid ionomer. A series of inks using different high-shear mixing times, from 15 to 60 minutes, is prepared. Following addition of the polymer and/or ionomer, the mixture is mixed via a non-shear methodology for anywhere from 15 minutes to 16 hours. The ink is applied to one side of the prepared MPL in multiple coats, until the catalyst loading is at the desired loading, which can be from 0.05 mg/cm² to 0.7 mg/cm² (either PGM or total catalyst depending on catalyst selection). The web and catalyst layer are air-dried in between each layer. A series of electrodes are prepared at different catalyst loadings for evaluation. Example 3—Cathode: An already-prepared MPL is used as a substrate. Catalyst inks are prepared using an aqueous/organic mixture, for example water and 1-propoanol. This mixture contains solvent, catalyst, for example a Platinum supported on XC-72 or KB-300, phosphonated polymer, and potentially sulfonic acid ionomer. A series of inks is prepared using different high-shear mixing times, from 15 to 60 minutes. Following addition of the polymer and/or ionomer, the mixture is mixed via a non-shear methodology for anywhere from 15 minutes to 16 hours. The ink is applied to one side of the prepared MPL in multiple coats, until the catalyst loading is at the desired loading, which can be from 0.05 mg/cm² to 1 mg/cm² (either PGM or total catalyst depending on catalyst selection). The web and catalyst layer are air-dried in between each layer. A series of electrodes are prepared at different catalyst loadings for evaluation.

Example 4—MPL and GDE Characterization: Catalyst layer thickness is evaluated using cross-section image analysis on a scanning electron microscope (SEM). Cross-section sample preparation and analysis is well-documented. Bubble point and mean pore size are evaluated using capillary flow porometry, whereby an increasing pressure of inert gas is used to remove a wetting agent that is introduced to the pores of the electrode. As the pressure is increased, wetting agent is removed from smaller pores. This evaluation is done on the base substrate, the completed microporous layer (before or after sintering), and the completed electrode including catalyst layer.

Example 5—Fuel cell Testing: employs 5 cm2 and 45 cm2 active area single cells and traditional graphite fields (2× parallel serpentine for anode, 3× parallel serpentine for cathode). Testing is done under both Hydrogen and Reformate mixes on the anode with Hydrogen composition from 25% to 100%, and under air and oxygen on the cathode, with potential low oxygen mixes also used (4% to 25%).

Described above are novel electrodes, membrane electrode assemblies and fuel cells, as well as methods of fabrication thereof, according to the invention. It will be appreciated that the embodiments discussed above and shown in the drawings are examples of the invention and that other embodiments incorporating changes to those shown here also fall within the scope of the invention.

In view of the foregoing, what we claim is:

1. A gas diffusion electrode consisting of a supported catalyst and ionomeric binder

2. A gas diffusion electrode of claim 1 for anodic fuel cell reactions with a bubble point between 15 and 60 microns

3. A gas diffusion electrode of claim 1 for anodic fuel cell reactions with a mean pore diameter between 4 and 10 microns

4. A gas diffusion electrode of claim 1 for cathodic fuel cell reactions with a bubble point between 35 and 45 microns

5. A gas diffusion electrode of claim 1 for cathodic fuel cell reactions with a mean pore diameter between 8 and 12 microns

6. A method of preparing an ink containing carbon supported precious metal catalysts whereby the solvent of the ink is a combination of water and one or more preferred solvents 1-propanol, iso-propanol, NMP, DMAC, DMSO, DMF, and cyclopentanone.

7. A gas diffusion electrode comprising
A. a carbon substrate layer,
B. microporous layer disposed on the carbon substrate layer, the microporous layer comprising a carbon and a hydrophobic binder, and
C. a catalyst layer disposed on the microporous layer.

8. The gas diffusion electrode of claim 7, where the hydrophobic binder comprises PTFE.

9. The gas diffusion membrane of claim 7, wherein the catalyst layer additionally comprises an ionomeric binder.

10. The gas diffusion membrane of claim 9, wherein the ionomeric binder comprises a phosphonated polymer.

11. The gas diffusion membrane of claim 10, wherein the catalyst layer comprises a sulfonic acid polyelectrolyte.

12. The gas diffusion membrane of claim 11, wherein the sulfonic acid polyelectrolyte comprises perfluorosulfonic acid.

13. The gas diffusion membrane of claim 7, comprising a topcoat layer disposed on the catalyst layer, where the topcoat layer comprises at least one of an ionomer and phosphoric acid.
